(19) United States
(12) Patent Application Publication
(10) Pub. No.: US 2010/0059688 A1
(43) Pub. Date: Mar. 11, 2010

(54) Method And Software For Irradiating A Target Volume With A Particle Beam And Device Implementing Same

(75) Inventors: Yves Claereboudt, Corbais (BE); Denis Demaret, Leuze (BE); Jean-Francois de Le Hoye, Brussels (BE)

Correspondence Address: FITCH EVEN TABIN & FLANNERY, 120 SOUTH LASALLE STREET, SUITE 1600, CHICAGO, IL, 60603-3406, US

(73) Assignee: ION BEAM APPLICATIONS S.A., Louvain-La Neuve (BE)

(21) Appl. No.: 12/307,205

(22) PCT Filed: Mar. 2, 2007
(86) PCT No.: PCT/EP2007/052019

§ 371 Date: Nov. 13, 2009

(30) Foreign Application Priority Data
Jul. 6, 2006 (EP) 06116754.0

(51) Int. Cl. H01J 3/26

(52) U.S. Cl. 250/397; 250/396 R

(57) ABSTRACT

The present invention is related to a method for treating or irradiating a target volume with a particle beam produced by an accelerator, comprising the steps of: deflecting said particle beam with the help of scanning means in two orthogonal (X, Y) directions, thereby constituting an irradiation plane perpendicular to the direction (Z) of the beam, defining in the irradiation plane a scanning field which circumscribes the area of intersection of target volume and irradiation plane and scanning said scanning field by drawing scan lines which form a scan pattern comprising interleaved frames of triangle waves. The scan pattern is preferably continuous and represents contiguous rhombi figures. The invention is equally related to a device and a software program or sequencer implementing the method.

### FIELD OF THE INVENTION

The present invention relates to a method and a software for irradiating a target volume with a particle beam, in particular a proton beam.

The present invention also relates to a device for carrying out said method.

The field of application is the proton therapy used in particular for the treatment of cancer, in which it is necessary to provide a method and device for irradiating a target volume constituting a phantom for delivery tests or a tumour to be treated.

### STATE OF THE ART

Radiotherapy is one of the possible ways for treating cancer. It is based on irradiating the patient, more particularly his or her tumour, with ionizing radiation. In the particular case of proton therapy, the radiation is performed using a proton beam. It is the dose of radiation thus delivered to the tumour which is responsible for its destruction.

In this context, it is important for the prescribed dose to be effectively delivered within the target volume defined by the radiotherapist, while at the same time sparing as much as possible the neighbouring healthy tissues and vital organs. This is referred to as the “conformation” of the dose delivered to the target volume. In order to reach a suitable conformation, a predefined radiation dose is calculated in order to reach a clinically useful dose distribution that conforms as much as possible with the shape of the target volume and contemporaneously spares the contiguous healthy tissues. Various methods which may be used for this purpose are known in proton therapy, and are grouped in two categories: “passive” methods and “active” methods.

Whether they are active or passive, these methods have the common aim of manipulating a proton beam produced by a particle accelerator so as to completely cover the target volume in the three dimensions: the “depth” (in the direction of the beam) and, for each depth, the two dimensions defining the plane perpendicular to the beam.

Among active methods, the pencil beam scanning is a very well known scanning method, wherein the movement of the particle beam is performed in two directions perpendicular to the direction of the beam defining the irradiation plane. The intersection of the beam with said irradiation plane is representing the spot of irradiation.

It is also observed that the conformation to the target volume is achieved without the use of variable collimators and solely by an optimal control of the path of movement of said spot. The target volume is cut into several successive layers of water-equivalent depth. The depthwise movement of the spot from one layer to another is achieved by modifying the energy of the particle beam.

More particularly, the movement in the two directions that are in the plane perpendicular to the direction of the beam takes place with the help of electromagnets controlling the position of the beam. This is performed by applying a current of a known magnitude to said electromagnets thereby generating a magnetic field of predictable intensity which allows the bending or deflecting of the beam (depending on the magnetic rigidity of the particles of the beam).

Preferably, the scanning in the irradiation plane takes place with the help of said electromagnets in such a way that a continuous movement of the spot is applied in the X, Y directions perpendicular to the direction Z.

Advantageously, the two electromagnets are positioned and acting to provide two orthogonal magnetic fields so as to guide the spot in the two directions X, Y. Actually, this scanning is performed so that only one of the two electromagnets is modifying its parameter, namely the current, while the current of the second electromagnet remains constant. As a result, while the scanning of the spot in one direction (e.g. X) is performed, the other coordinate (e.g. Y) is considered as constant.

The scanning along lines which are parallel to one of the two scanning magnets (e.g. X) is very demanding on the drive for such magnets. In fact, in order to control such scanning magnets in DC mode would require a current drive and magnet capable of a much higher power dissipation.

### AIMS OF THE INVENTION

The present invention aims to provide a method, a software and a device for irradiating a target volume with a particle beam, which avoid the drawbacks of the methods described previously, while at the same time making it possible to deliver a dose to a target volume with the greatest possible conformity and/or flexibility.

The present invention aims in particular to provide a method, a software and a device which dispense with a large number of auxiliary elements such as collimators, compensators, diffusers or even path modulators.

The present invention aims also to provide a method, a software and a device which make it possible to obtain protection against an absence of emission of the beam (blank or hole) or against an interruption of the movement of said beam.

In particular, the present invention aims to provide a method, a software and a device which make it possible to obtain a ratio of highest to lowest dose in the target volume ranging from 1 to 500.

### SUMMARY OF THE INVENTION

The present invention is related to a method, a software and a device, as set out in the appended claims, for treating or irradiating a target volume with a particle beam produced by an accelerator. The method, the software implementation and the device of the invention are arranged to be manipulated by a physicist or a mathematician. They are not intended to be manipulated by general clinicians.

According to a first aspect of the invention there is provided a method for treating or irradiating a target volume with a particle beam. The method of the invention comprises the steps of: deflecting said particle beam with the help of scanning means in two orthogonal (X, Y) directions, thereby constituting an irradiation plane perpendicular to the direction (Z) of the beam; defining in the irradiation plane a scan field which circumscribes the area of intersection of target volume and irradiation plane; and scanning said scan field along a multiple of two interleaved frames of triangle waves.

A triangle wave is a cyclic wave form of triangular shape. It is also referred to as a zigzag wave. Mathematically, this wave form results from a superposition of a sine wave having the same fundamental frequency as the triangle wave with an infinite series of odd harmonics of said sine wave. The present invention is however not limited to only pure triangle waves. All intermediate wave forms between a triangle wave and its corresponding fundamental sine wave may also be used to put the method of the invention into practice. In particular, a triangle wave where the apices are rounded off is suited for the method of the invention. As a wave mathematically speaking propagates to infinity, a frame of a wave is considered, the frame being a piece of that wave, having a finite length.

Preferably, in the method of the invention, the interleaved frames of triangle waves form a scan pattern which comprises contiguous rhombi or rhombus-like figures. Two contiguous rhombi or rhombus-like figures are contiguous in at least two points to each other. Preferably, in the interleaved frames, each half-period segment of a triangle wave intersects at least three other triangle waves.

Preferably, the frames of triangle waves are equidistantly interleaved. The interleaved frames are scanned consecutively. Preferably, the transition between two interleaved frames of triangle waves, which are scanned consecutively, is continuous.

Half of the interleaved frames of triangle waves are scanned from one edge of the scan field to an opposite edge of said scan field (forward scan). The other half of the frames of triangle waves are scanned from said opposite edge back to said one edge (backward scan). In the interleaving of the frames, a frame which is scanned forward is always directly followed by a frame which is scanned backward.

Preferably, the scan field comprises an overscan area for changing the scanning direction. In the overscan area the scanning means, which may be scanning magnets, may change polarity in order to invert the trajectory of scanning in one of the two scan directions (X or Y). The trajectory of scanning may comprise an arc where inversion occurs, i.e. the sharp apices or angles of the triangle waves are rounded.

The triangle waves are obtained by scanning with a scan frequency along two orthogonal directions (X and Y directions). Preferably, the method of the invention comprises the step of selecting a couple of scan frequencies along the X and Y directions satisfying a set of constraints or requirements for generating the interleaved frames of triangle waves. The set of constraints or requirements are defined to be one or more of the following parameters:
the time required for the generation of the whole pattern;
the maximum achievable variation of current in the scanning means;
the minimum achievable variation of current in the scanning means;
the maximum power dissipation in the scanning means;
the size of the scan field in one or both of the X and Y directions;
the minimum time required to change the polarity of the voltage in the scanning means;
the linear scanning speed;
the maximum and/or minimum frequency of the triangle wave form and
the distance between 2 adjacent parallel lines of the scan pattern.

Preferably, from a set of possible solutions, the couple of scan frequencies that minimize or maximize one of the parameters is selected. More preferably, the ratio of the couple of scan frequencies along the X and Y directions is equal to the ratio of a natural number k to the number N of interleaved frames of triangle wave forms and wherein the greatest common divisor of k and N is different from 1.

Preferably, the method for treating or irradiating a target volume of the invention further comprises the step of applying a continuous scanning movement in the Z direction by modifying the energy of the beam during the scanning of the beam in the (X, Y) directions perpendicular to the direction (Z) of the beam, thereby performing a continuous 3D scanning of the target volume.

Preferably, the method for treating or irradiating a target volume of the invention further comprises the step of continuously modifying the beam intensity during irradiation.

Preferably, in the method of the invention, the interleaved frames of triangle wave forms are scanned consecutively.

Preferably, the method for treating or irradiating a target volume of the invention comprises the step of irradiating portions of the wave frames so as to deliver a dose that conforms to the target volume. More preferably, the scan pattern is scanned multiple times. Each time the scan pattern is scanned, the target volume receives a portion of the total dose to be delivered. At each scanning of the scan pattern (referred to as repainting), the scan pattern is preferably an exact superposition of the initial (first) scanned pattern.

According to a second aspect of the invention, there is provided a device for irradiating a target volume through a particle beam produced by an accelerator. The device of the invention preferably comprises all the adequate means to put the method of the invention into practice. The particle beam generates a spot located within the target volume. Three coordinates (x,y,z) are associated with the spot, the third coordinate (z) corresponding to the beam direction Z, while the two first coordinates (x,y) correspond to the directions X and Y orthogonal to said third direction. Said x and y coordinates are obtained with scanning means deflecting the particle beam along two orthogonal directions X and Y while the z coordinate is obtained with energy variation means. The device of the invention comprises control means adapted to control continuously the scanning means in order to allow the spot to be scanned in the X,Y plane according to a scan pattern comprising interleaved frames of triangle waves.

Preferably, the control means are arranged to move the spot continuously during the scanning of the scan pattern. The interleaved frames of waves form a continuous scan pattern.

Preferably, the scanning means and energy variation means allow to scan the irradiation volume several times. More preferably, the energy variation means allow the spot to be moved continuously within the volume in all three directions of space.

Preferably, the control means comprise a feedback loop arranged for correcting in real time the scanned trajectory. More preferably, the control means is adapted to synchronize the scanning of a spot, and the irradiation of the spot by the particle beam.

Preferably, the device of the invention comprises a computer system or sequencer arranged for implementing a planning and control algorithm allowing to determine beam intensity and scan speed for each irradiation volume as well as frequencies of scanning the scan pattern according to the X and Y directions in order to deliver a predetermined dose to each irradiation volume.

Preferably, the device of the invention comprises at least one detection device such as an ionization chamber and/or a diagnostic element, allowing measurements to be performed so as to check the conformation of the irradiation dose to the target volume.

According to a third aspect of the invention, there is provided a software program for being run on a computer and arranged for generating controlling commands to the scanning means of a device for irradiating a target volume by a particle beam. The software program implements a planning and control algorithm for determining and controlling the trajectory to be scanned which forms a scan pattern comprising interleaved frames of triangle waves. The scan pattern is preferably planned and controlled according to the method of the invention.

Preferably, the software program is arranged for selecting a couple of scan frequencies along the X and Y directions according to the method of the invention.

According to a fourth aspect of the invention there is provided a use of the method and/or the device of the invention in cancer therapy. The method and device of the invention hence may be used for the treatment of cancer.

### BRIEF DESCRIPTION OF THE FIGURES

All drawings are intended to illustrate some aspects and embodiments of the present invention. The drawings described are only schematic and are non-limiting.

FIG. 1 schematically represents the irradiation of a target volume by a scanned charged particle beam using an active method.

FIG. 2 represents a scan pattern of two interleaved triangle waves.

FIG. 3 represents a preferred embodiment of a scan pattern for the spot in an irradiation plane according to the present invention. The scan pattern consists of four interleaved frames.

FIG. 4 represents a preferred embodiment of a scan pattern for the spot in an irradiation plane according to the present invention. The enlarged sections show the radii of the beam trajectory at the inversion points.

FIG. 5 represents a preferred embodiment of a scan pattern having 12 interleaved wave forms.

FIG. 6 represents a graph of the ratio of current frequency of the Y scanning magnet (Fy) to the current frequency of the X scanning magnet (Fx) according to different values of k/N where k is a natural number and N is the number of interleaved wave forms.

FIG. 7 represents a graph analogous to FIG. 5, wherein additional constraints are represented and showing the location of optimal values for the frequency ratio.

FIG. 8 represents the conformation of a target area with an irradiation area along scan lines.

### DETAILED DESCRIPTION OF THE INVENTION

One or more embodiments of the present invention will now be described in detail with reference to the attached figures, the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Those skilled in the art can recognize numerous variations and modifications of this invention that are encompassed by its scope. Accordingly, the description of preferred embodiments should not be deemed to limit the scope of the present invention.

Furthermore, the terms first, second and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein. For example “underneath” and “above” an element indicates being located at opposite sides of this element.

It is to be noticed that the term “comprising”, used in the claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

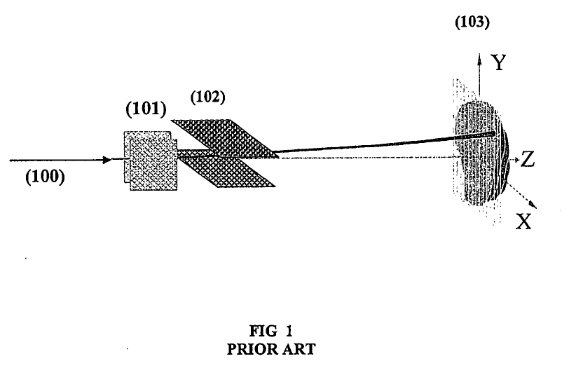

FIG. 1 partially shows a device for treating a particle beam produced by an accelerator devoted to the irradiation of a target volume consisting, for example, of a tumour to be treated in the case of a cancer or a phantom for delivery tests. A cyclotron (not shown) is used to produce a proton beam 100 generating a spot to be moved. Means (not shown) are provided for modifying the energy of the proton beam immediately after it is extracted from the accelerator in order to allow the movement of the spot in the longitudinal dimension, that is to say in the direction of the beam, so as to define the Z coordinate. For clarity, the figure shows the very specific case of a homogenous target, where irradiation layers of water-equivalent depth are completely perpendicular to the beam, defining parallel planes.

Two scanning magnets, 101 and 102, oriented so as to create orthogonal magnetic fields, deflect the beam 100 in order to scan the irradiation plane 103. The scanning area in plane 103 is restricted to a certain scanning field size, generally of rectangular shape, which circumscribes the irradiation area. The scan pattern as represented in FIG. 1 belongs to the prior art and consists of lines parallel to one of the axes of the scanning magnets (Y in the case of FIG. 1).

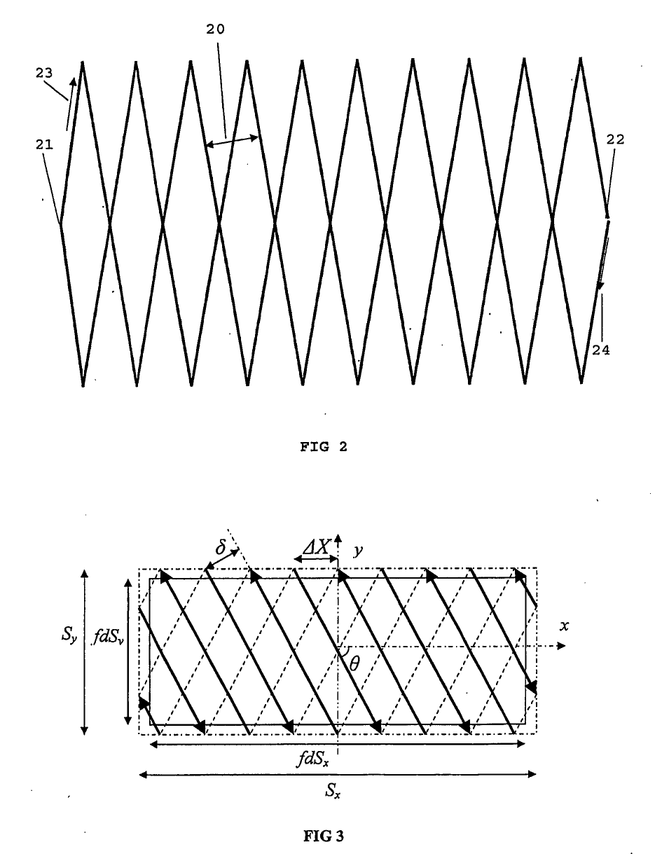

In order to alleviate the high power dissipation demands during scanning, a type of scan pattern is classically used in which the current flowing through the scanning magnets is triangle-shaped of a determined frequency. The scanned beam draws a triangle wave form as represented in FIG. 2. The scanning of such pattern may start at point 21, which lies on the edge of the scanning area (scan field, also called irradiation field). The scanning is performed in the direction 23, following a triangularly shaped path (also called a zigzag path) until point 22 is reached at an opposite edge of the scan field. The scanning of this wave is referred to as a forward scan. Thereafter, a scanning is performed back to the starting point 21, now along a direction 24. The scanning of this wave is referred to as a backward scan. The triangle wave in the direction 23 and the triangle wave in the direction 24 are mirror images of each other, i.e. the two wave forms have the same amplitude and frequency but show a phase shift of 180°. When wave forms of FIG. 2 are obtained with two orthogonal scan magnets (one scanning horizontally and the other vertically in FIG. 2), one magnet scans at a highest frequency (the magnet scanning along the vertical axis in the case of FIG. 2), while the other, perpendicularly arranged scanning magnet scans at a lower frequency (the magnet scanning along the horizontal axis in the case of FIG. 2). A necessary condition to obtain the scan pattern of FIG. 2 is to choose the period of the triangle wave forms such that a multiple of half said period is equal to the scan field size along the direction of triangle wave propagation.

The resulting scan spacing 20 is hence a function of the scan frequencies, Fx and Fy, of the two scanning magnets 101 and 102. A small scan spacing would imply a very high scan frequency of one scanning magnet and a very slow scan frequency of the other scanning magnet, which may not be achievable by some magnets or some power supplies of the magnets.

In the present invention, a much broader range of scan spacings can be achieved by interleaving frames of triangle wave forms of the kind of FIG. 2. The interleaving does not place any additional burden on the scanning magnets and their power supplies, and may be implemented on existing particle beam irradiation facilities, taking their existing constraints into account. Assuming that a single triangle wave form has a scan spacing δ (orthogonal distance between two parallel lines of the wave form), then equidistantly interleaving N frames of triangle wave forms would result in a scan spacing δ_{N}=δ/N. The scan spacing may hence be considerably reduced while keeping the same range of scan frequencies Fx and Fy as in the non-interleaved case. The interleaved wave frames are scanned in a consecutive fashion.

As stated earlier, the present invention is not limited to pure triangle waves, but also to wave forms intermediate between a triangle wave and its corresponding fundamental sine wave. Such an intermediate wave form may be a triangle wave with rounded apices. In the present disclosure, the term triangle should be interpreted in that broad meaning.

Another way of looking at the method of interleaving is as follows. In the case of FIG. 2, two times the size of the scan field in the direction of wave propagation is always equal to a multiple of the period of the triangle wave, because the starting point 21 of the forward scanning (direction 23) triangle wave coincides with the end point of the backward scanning (direction 24) triangle wave. When interleaving triangle waves, the scanning is performed along multiple forward and backward scanned triangle waves, all having identical amplitude and frequency, in which the starting point of the first forward scanned triangle wave coincides with the end point of the last backward scanned triangle wave. A forward scanned triangle wave is always followed by a backward scanned triangle wave and the end point of a forward scanned wave frame constitutes the starting point of the consecutive backward scanned triangle wave frame. This means that when N triangle wave frames are interleaved, N times the size of the scan field in the direction of wave propagation must be essentially equal to a multiple of the period of the triangle wave. The term “essentially” in the previous sentence stems from the fact that the transition point between a forward scanning and a backward scanning wave may not be sharp, but the scan path may be rounded, as is shown in FIG. 4 (116).

N interleaved frames of triangle waves may be considered as a single wave propagating in a frame having length equal to N times the field size along the direction of wave propagation, which is then “folded up” N times, at each multiple of the field size. When N times the field size is equal to a multiple of the period of the triangle wave, starting point and end point of the triangle wave will coincide after the “folding up”. The “folding up” is equal to imparting to the subsequent wave frame a 180° phase shift. The scan field size along the direction of wave propagation may not be equal to a multiple of half the period of the triangle wave, otherwise a degenerated scan pattern is obtained, wherein all the forward and backward scanning waves overlap, i.e. the 180° phase shift results again in the first forward or the first backward scanning wave.

The interleaved triangle scan pattern is preferably calculated in function of the irradiation specifications (e.g. scan spacing). The calculation is furthermore subjected to a number of requirements/constraints. Therefore, it is an aim of the invention to use an optimal scan pattern of interleaved frames of triangle waves, which satisfies the irradiation specifications and the constraints and which is optimized in order to minimize or maximize a selected parameter. Preferably, the optimal scan pattern minimizes the irradiation time.

The constraints can be one or more of the following parameters:
the maximum achievable variation of current in one of the two scanning magnets;
the minimum achievable variation of current in one of the two scanning magnets;
the maximum power dissipation in one of the scanning magnets;
the size of the target area in one or both of the 2 directions of scanning;
the size of the overscan in order to avoid edge effects at the boundaries of the irradiation field; the irradiation field is therefore extended at each edge by an overscan field size;
the minimum time required to change the polarity of the voltage on one of the scanning magnets;
the linear speed of the beam along the target;
the maximum and/or minimum frequency of the triangle in one or both scanning magnet(s);
the distance between two adjacent parallel lines of the scan pattern (scan spacing).

The above constraints may be put into equation. A set of equations may hence be derived, based on which optimal scanning frequencies Fx and Fy are obtained, respectively for the scanning magnets in X and Y direction. The found frequencies satisfy all identified constraints, which may be some or all of the abovementioned constraints.

The interleaving of the frames is hence subjected to a number of requirements and specifications. These result from the equipment, the equipment controls and from clinical aspects.

A first requirement might be to have a scan pattern (of interleaved frames) which is centred with regard to the centre of the irradiation field (scan field). The scan pattern must go through the centre of the scan field. This might be forced by the methodology used to compute the dose to be delivered on each point and might ease the treatment planning.

A second requirement might be to avoid kicks of instabilities at the edges of the scan area. Hence, the end point of one frame should preferably be the starting point of the subsequent frame.

A third requirement is that no constraint may be put on the slope of the scan lines.

The inventors have found that the above requirements are met by scan patterns of interleaved frames, for which the frames correspond to a subset of rational frequency ratios (ratio of frequency of one scanning magnet to the other scanning magnet):

Fy/Fx=k/N

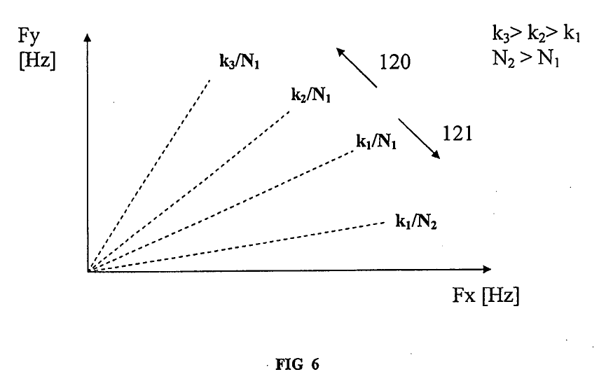

with k,N natural numbers and N the number of interleaved frames. When drawn in a Fx-Fy plane, the above subset results in straight lines intersecting the origin of the Fx-Fy plane and having slope k/N, as shown in FIG. 6. For increasing value of k the lines shift in direction 120. For increasing value of N the lines shift in direction 121.

Not all k/N values result in suitable frequency ratios. k/N values for which the greatest common divisor GCD is not 1 lead to degenerated trajectories for which the interleaved frames overlap. Hence, GCD(k,N)=1 is a constraint for having an appropriate Fy/Fx.

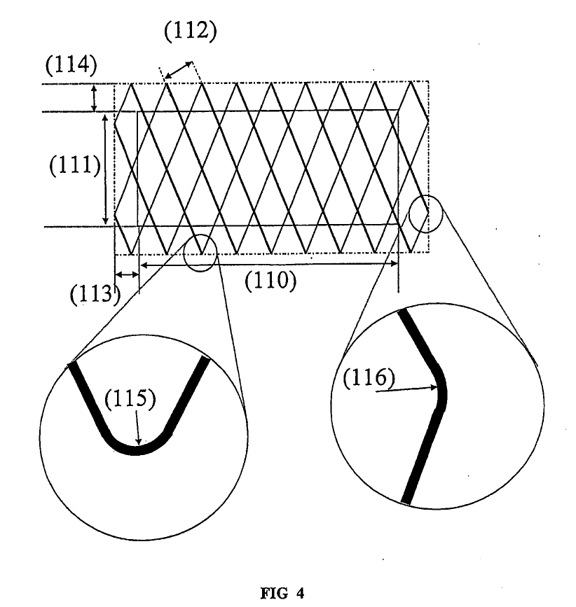

By way of example, a set of equations can be set up that describes the scan pattern with interleaved frames. Referring to FIG. 3, representing a scan pattern with two interleaved triangle frames, δ is the scan spacing, θ is the angle of the scan lines with the x-axis, ΔX is the distance between two parallel scan lines along the x-axis, fdSₓ is the field size along x, fdS_{y} is the field size along y, Sₓ is the field size along x including the overscan and S_{y} is the field size along y including the overscan. We then may write the following set of equations governing the interleaved pattern of FIG. 3, with α=k/N, GCD(k,N)=1 and p=tan(θ):

$$δ = \frac{p \cdot Δ X}{\sqrt{1 + {p}^{2}}}$$

$$Δ X = \frac{{S}_{x}}{N α}$$

$${S}_{x} = \frac{α {S}_{y}}{p}$$

The above set of equations contains a total of 8 variables: k, N, α, p, θ, [symbol] X, Sₓ and S_{y} for 5 equations. This means that some additional constraints may be chosen in order to have a unique solution. This allows for optimizing the interleaved scan pattern of the invention.

The method found by the inventors to calculate the optimal interleaved pattern and hence the 8 variables above comprises the following steps:
calculate S_{y} to be the smallest value meeting the constraints;
search k and N to obtain an optimal frequency ratio α and
calculate the remaining variables from the remaining equations (S_{y}, k and N are known, the remaining 5 variables can be calculated from the 5 equations).

Constraints in the calculation of S_{y} are the maximal achievable linear speed along the y-axis and geometric constraints regarding the inversion of the trajectory at the boundary of the field size.

FIG. 4 shows a scan pattern with two interleaved triangle frames, wherein 110 represents the field size in a first direction (e.g. x), 111 represents the field size in a second direction (e.g. y), 113 represents the overscan in the first direction and 114 represents the overscan in the second direction. An overscan is necessary in order to be able to invert the scanning trajectory at a boundary of the scan field. At an inversion point, the direction of the scanning trajectory is inverted with reference to an axis (x or y). The inversion of the trajectory occurs with a radius 115 or 116. Radius 115 refers to an inversion in the second direction (y) and radius 116 refers to an inversion in the first direction (x).

The radii 115 and 116 result from the limitation in voltage change applied to the scanning magnets. In order to change the current running through the coils of the magnets, a voltage change has to be applied. The rate of change of that voltage is limited. The amount of overscan needed to execute an inversion of the scanning trajectory along an axis also depends on the scanning speed along that axis. The higher the speed, the larger the overscan area will have to be. The total scan field S_{y} may not exceed the maximal scan field defined by the range of the scanning magnets. A suitable S_{y} is calculated which corresponds to a scanning speed in the y-direction which is as high as possible.

When a suitable S_{y} has been found, optimal values for k and N are searched for. The criterion governing this search is a minimal scanning time for the entire interleaved pattern. The scanning time for the interleaved pattern can be calculated by multiplicating the number of interleaved frames (N) by the time for scanning one frame (1/Fx). Hence the pattern scanning time: t(pattern)=N/Fx. In order to minimize the pattern scanning time, the number of interleaved frames should be reduced to a minimum and the scanning frequency along the x-axis should be increased to a maximum.

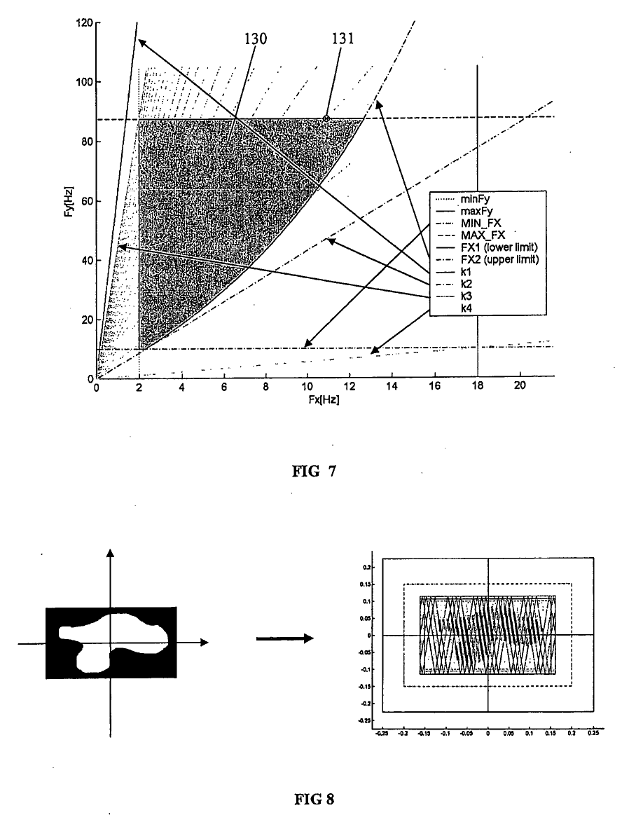

The search for an optimal k and N may be performed iteratively. Such a search starts at the lowest possible value for N. For each current value of N, a k-value should be searched for, making Fx maximal. It is clear from this optimisation that the optimal window of operation in a Fx-Fy plane lies close to the maximal value of Fx satisfying the constraints. FIG. 7 represents a graph of the Fx-Fy plane. The window of operation satisfying the constraints is represented by numeral 130. The optimal value 131 of Fx and Fy lies close to the maximal value of Fx within window 130. As shown in FIG. 7, the optimal value may lie near the maximal value of Fy satisfying the constraints.

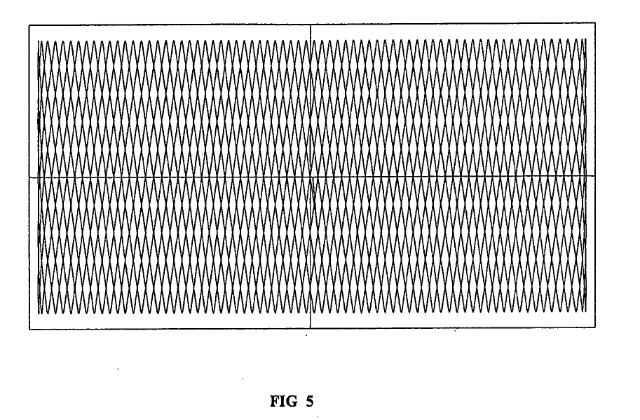

By way of example, FIG. 5 shows a scan pattern of the invention with twelve interleaved scan frames. Even though the whole rectangular field is scanned, the field may not be entirely irradiated. The irradiation area must conform with the target area. FIG. 8 shows on the left-hand side a target area (white) circumscribed within a scan field (black rectangle). On the right-hand side the scan pattern is shown. Only on the bold-marked scan lines would irradiation take place. The conformity of the irradiated area with the shape of the target area (tumour area) is achieved by a precise synchronization of trajectory and beam intensity. As shown on the right-hand graph of FIG. 8, the irradiation may take place only along parallel lines according to one slope of the scan pattern. This is clearly indicated in FIG. 3 by the arrow lines. Irradiation may take place only along the arrow lines and not along the dashed lines. In an alternative embodiment, two or more treatment plans may be mixed so as to irradiate the target area along both directions of the scan pattern (according to the two slopes). Equally possible is that irradiation along both directions of the scan pattern is provided by one treatment plan.

The methodology that is followed in the present invention determines Fx and Fy with the aid of a planning and processing computer software. During the irradiation, dose maps are permanently set up with the aid of measurements carried out by detection devices such as ionization chambers and other diagnostic elements. The frequencies Fx and Fy relating to the pattern can also be modified in real time and preferably simultaneously.

By envisaging to simultaneously vary the current in both orthogonal electromagnets, it is possible to obtain an adjustment of the dose to be delivered with increased flexibility/conformity.

According to a preferred embodiment, it can be also suggested to apply a continuous movement to said spot in the Z direction by modifying the energy of said beam during the scanning of the beam in the (X, Y) directions perpendicular to the direction (Z) of the beam, thereby performing a continuous 3D scanning of the target volume.

According to another preferred embodiment, it can also be suggested to continuously modify the scanning speed of the spot in the irradiation plane (X, Y) or in the 3D directions (X, Y, Z).

According to another preferred embodiment the beam intensity may be continuously modified.

More preferably, the intensity of the beam and the scanning speed can be instantaneously recalculated and readjusted so as to ensure that the prescribed dose is effectively delivered to the target volume.

According to a preferred embodiment, it is envisaged to cover the volume target several times in order to limit the dose delivered during each passage, which increases the safety while at the same time limiting the problems of over and under dosage due to the movements of the organs inside the body, for instance the breathing or heart beating.

As it is sometimes desirable to irradiate the volume several times (=repainting), the device is capable of optimizing the speed at which the intensity of the incident beam is modified to the amount of dose to be deposited and to the number of times that the volume needs to be repainted. At each repainting, the same scan, pattern is repeated, such that the beam irradiates the same spots. As the scan pattern of the invention is a pattern of continuous lines in which the beam may start and end at the same point, the repainting of the same spots is easily achieved.

Preferably, the dose delivered during each passage represents a maximum of about 2% of the total dose to be delivered for each voxel or irradiation volume.

It is thus observed, in a particularly advantageous manner, that the method and the device according to the present invention do not use elements such as collimators, compensators, diffusers or path modulators, which makes the implementation of said method significantly less cumbersome.

In addition, it is observed that, according to the present invention, no movement of the patient is involved. The irradiation procedure resulting therefrom will be less cumbersome, faster and more accurate. Therefore, it will also be less expensive. Better conformation of the dose delivered to the target volume will thus be obtained, and in a minimum amount of time.

1. A method for irradiating a target volume with a particle beam produced by an accelerator, comprising the steps of:
deflecting the particle beam with a scanning device in two X and Y directions, which are orthogonal and configured to provide an irradiation plane perpendicular to a Z direction of the beam,
defining in the irradiation plane a scan field which circumscribes an area of intersection of the target volume and the irradiation plane, and
scanning the scan field along a multiple of two interleaved frames of triangle waves.

2. The method according to claim 1, wherein the interleaved frames of triangle waves form a scan pattern comprising rhombi figures, two contiguous rhombi figures being contiguous to each other in at least two points.

3. The method according to claim 1, wherein the frames of triangle waves are equidistantly interleaved.

4. The method according to claim 1, wherein the transition between two interleaved frames of triangle waves is continuous.

5. The method according to claim 1, wherein the scan field comprises an overscan area for changing the scanning direction.

6. The method according to claim 1, comprising the step of selecting a couple of scan frequencies along the X and Y directions satisfying at least one requirement for generating the interleaved frames of triangle waves, wherein the at least one requirement is selected from the group of parameters consisting of:
time required for generation of a whole pattern of wave frames;
maximal achievable variation of current in the scanning device;
minimal achievable variation of current in the scanning device;
maximal power dissipation in the scanning device;
size of the scan field in at least one of the X and Y directions;
minimum time required to change polarity of voltage in the scannings device,
linear scanning speed;
maximum frequency of the triangle wave form;
minimum frequency of the triangle wave form; and
distance between 2 adjacent parallel lines of the interleaved frames of triangle waves.

7. The method according to claim 6, wherein from a set of possible solutions, the couple of scan frequencies that minimize or maximize one of the parameters is selected.

8. The method according to claim 6, wherein the ratio of the couple of scan frequencies along the X and Y directions is equal to the ratio of a natural number k to the number N of interleaved frames of triangle waves and wherein the greatest common divisor of k and N is different from 1.

9. The method according to claim 1, further comprising the step of applying a continuous scanning movement in the Z direction by modifying the energy of the beam during the scanning of the beam in the X and Y directions perpendicular to the Z direction of the beam, thereby performing a continuous 3D scanning of the target volume.

10. The method according to claim 1, further comprising the step of continuously modifying the beam intensity during irradiation.

11. The method according to claim 1, wherein the interleaved frames of triangle waves are scanned consecutively.

12. The method according to claim 1, comprising the step of irradiating portions of the waves so as to deliver a dose that conforms to the target volume.

13. An apparatus for irradiating a target volume through a particle beam produced by an accelerator, wherein the particle beam generates a spot located within the target volume, with the spot being associated three coordinates (x,y,z), the coordinate (z) corresponding to beam direction Z while coordinates (x,y) correspond to directions X and Y orthogonal to the direction Z and to one another, the x and y coordinates being obtained with a scanning device deflecting the particle beam along directions X and Y while the z coordinate is obtained with an energy variation device, wherein the apparatus comprises a control device adapted to control continuously the scanning device in order to allow the spot to be scanned in the X, Y plane according to a scan pattern comprising a multiple of two interleaved frames of triangle waves.

14. The apparatus according to claim 13, wherein the interleaved frames of waves form a continuous scan pattern.

15. The apparatus according to claim 13, wherein the scanning device and the energy variation device allow scan of the irradiation volume several times.

16. The apparatus according to claim 13, wherein the energy variation device allows the spot to be moved continuously within the volume in all three directions of space.

17. The apparatus according to claim 13, wherein the control device comprises a feedback loop arranged for correcting in real time a scanned trajectory.

18. The apparatus according to claim 13, comprising a computer system arranged for implementing a planning and control algorithm for determining beam intensity and scan speed for each irradiation volume as well as frequencies of scanning the scan pattern in the X and Y directions in order to deliver a predetermined irradiation dose to each irradiation volume.

19. The apparatus device according to claim 18, comprising at least one detection device allowing measurements to be performed so as to check the conformation of the irradiation dose to the target volume.

20. The apparatus according to claim 13, wherein the control device is adapted to synchronize scanning of a spot with irradiation of the spot by the particle beam.

21. A computer software program for being run on a computer and arranged for generating controlling commands to the scanning device of the apparatus of claim 13, the software program implementing a planning and control algorithm for determining and controlling a trajectory to be scanned which forms a pattern comprising a multiple of two interleaved frames of triangle waves.

22. The software program according to claim 21, arranged for selecting a couple of scan frequencies along the X and Y directions satisfying at least one requirement for generating the interleaved frames of triangle waves, wherein the at least one requirement is selected from the group consisting of: time required for generation of the whole pattern of wave frames; maximal achievable variation of current in the scanning device; minimal achievable variation of current in the scanning device; maximal power dissipation in the scanning device; size of the scan field in at least one of the X and Y directions; minimum time required to change polarity of voltage in the scanning device; linear scanning speed; maximum frequency of the triangle wave form; minimum frequency of the triangle wave form; and distance between 2 adjacent parallel lines of the interleaved frames of triangle waves.

23. (canceled)

24. The apparatus according to claim 13, comprising a sequencer arranged for implementing a planning and control algorithm for determining beam intensity and scan speed for each irradiation volume as well as frequencies of scanning the scan pattern in the X and Y directions in order to deliver a predetermined irradiation dose to each irradiation volume.

25. The apparatus of claim 19, wherein the at least one detection device is an ionization chamber.

26. The apparatus of claim 19, wherein the at least one detection device is a diagnostic element.

27. A method of treating cancer comprising utilizing the apparatus according to claim 13.
